(19) United States
(12) Patent Application Publication
(10) Pub. No.: US 2026/0148966 A1
(43) Pub. Date: May 28, 2026

(54) NEGATIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventor: Injoe JUNG, Yongin-si (KR)

(73) Assignee: SAMSUNG SDI CO., LTD., Yongin-si (KR)

(21) Appl. No.: 19/395,944

(22) Filed: Nov. 20, 2025

(30) Foreign Application Priority Data
Nov. 25, 2024 (KR) 10-2024-0169724

(51) Int. Cl. H01M 4/36; H01M 4/02; H01M 10/0525

(52) U.S. Cl. CPC H01M 4/364; H01M 10/0525; H01M 2004/021; H01M 2004/027

(57) ABSTRACT

The present disclosure relates to a negative electrode for a rechargeable lithium battery, and includes a negative electrode current collector; and a negative electrode active material layer on the negative electrode current collector. The negative electrode active material layer includes a negative electrode active material and a binder. The negative electrode active material layer includes a first region adjacent to a surface of the negative electrode active material layer; and a second region between the first region and the negative electrode current collector. A mixture density of the first region is less than a mixture density of the second region.

### CROSS-REFERENCE TO RELATED APPLICATION

This U.S. nonprovisional application claims priority under 35 U.S.C § 119 to Korean Patent Application No. 10-2024-0169724 filed on Nov. 25, 2024 in the Korean Intellectual Property Office, the entire disclosure of which is incorporated hereby by reference.

### BACKGROUND

The present disclosure relates to a negative electrode for a rechargeable lithium battery, and a rechargeable lithium battery including the negative electrode, and more particularly to a negative electrode having a different mixture density, and a rechargeable lithium battery including the negative electrode.

With the increase of battery-powered electronic devices such as, e.g., mobile phones, notebook computers, electric vehicles, and the like, the demand for rechargeable batteries with high energy density and large capacity is increasing. In response, research and development efforts have been made to enhance the performance of rechargeable lithium batteries.

A rechargeable lithium battery generally includes a positive electrode, a negative electrode, and an electrolyte. Both the positive and negative electrodes contain active materials capable of lithium-ion intercalation and deintercalation. Electrical energy is generated through oxidation and reduction reactions as lithium ions move between the electrodes during charging and discharging.

### SUMMARY

An example embodiment of the present disclosure provides a negative electrode for a rechargeable lithium battery having a desired or improved capacity and improved charge-discharge characteristics, and a rechargeable lithium battery including the negative electrode.

According to an example embodiment of the present disclosure, a negative electrode for a rechargeable lithium battery may include a negative electrode current collector, and a negative electrode active material layer on the negative electrode current collector. The negative electrode active material layer includes a negative electrode active material and a binder. The negative electrode active material layer includes a first region adjacent to a surface of the negative electrode active material layer; and a second region between the first region and the negative electrode current collector. A mixture density of the first region is smaller than a mixture density of the second region. A thickness of the first region may be a depth from the surface to a point having a specific mixture density. The specific mixture density is in a range of about 0.7 times to about 0.95 times an average mixture density of the negative electrode active material layer. A ratio of the thickness of the first region to a thickness of the negative electrode active material layer may be in a range of about 0.01 to about 0.1.

According to an example embodiment of the present disclosure, a negative electrode for a rechargeable lithium battery may include a negative electrode current collector, and a negative electrode active material layer on the negative electrode current collector. The negative electrode active material layer includes a negative electrode active material and a binder. The negative electrode active material layer includes a first region adjacent to a surface of the negative electrode active material layer, and a second region between the first region and the negative electrode current collector. A porosity of the first region is greater than a porosity of the second region. A thickness of the first region may be a depth from the surface to a point having a specific mixture density. The specific mixture density is in a range of about 0.7 times to about 0.95 times an average mixture density of the negative electrode active material layer. A ratio of the thickness of the first region to a thickness of the negative electrode active layer is in a range of about 0.01 to about 0.1.

According to an example embodiment of the present disclosure, a rechargeable lithium battery may include the negative electrode, a positive electrode that includes a positive electrode current collector and a positive electrode active material layer on the positive electrode current collector, and a separator between the negative electrode and the positive electrode.

### BRIEF DESCRIPTION OF DRAWINGS

FIG. 1 is a simplified conceptual diagram illustrating a rechargeable lithium battery according to example embodiments of the present disclosure.

FIGS. 2 to 5 are diagrams illustrating a rechargeable lithium battery according to example embodiments of the present disclosure.

FIG. 6 is a cross-sectional view illustrating a rechargeable lithium battery according to example embodiments of the present disclosure.

FIG. 7 is a cross-sectional view illustrating a negative electrode for a rechargeable lithium battery according to an example embodiment of the present disclosure.

FIGS. 8A and 8B are cross-sectional views illustrating negative electrodes for a rechargeable lithium battery, according to another example embodiment of the present disclosure.

FIG. 9 is a plan view of a negative electrode active material layer according to another example embodiment of the present disclosure.

FIG. 10 is a flowchart illustrating a method for manufacturing a negative electrode for a rechargeable lithium battery, according to an example embodiment of the present disclosure.

FIG. 11 is a diagram illustrating step S100 of FIG. 10.

FIG. 12 is a diagram illustrating step S200 of FIG. 10.

FIG. 13 is a diagram illustrating step S300 of FIG. 10.

### DETAILED DESCRIPTION

To fully understand the configuration and effects of the present disclosure, some example embodiments are described with reference to the accompanying drawings. However, the present disclosure is not limited to the following example embodiments, and may be implemented in various forms. The example embodiments are provided solely to illustrate the present disclosure and to enable those skilled in the art to fully understand the scope thereof.

In this description, when an element is described as being “on” another element, the element may be directly on the other element, or one or more intervening elements may be present. In the drawings, certain thicknesses may be exaggerated to better illustrate technical details. Throughout the specification, like reference numerals indicate like elements.

Unless otherwise explicitly stated in this description, singular forms may also include plural forms. In addition, unless explicitly stated otherwise, the phrase “A or B” may indicate “A but not B,” “B but not A,” and “A and B.” The terms “comprises/includes” and “comprising/including” do not exclude the presence or addition of one or more other components.

In this description, the phrase “combination thereof” may refer to a mixture, a stack, a composite, a copolymer, an alloy, a blend, or a reaction product.

Unless otherwise specifically defined, the term “particle diameter” refers to an average particle diameter. The particle diameter may represent the median particle size (D50), which corresponds to the diameter of particles at 50 vol % in a cumulative particle size distribution. The average particle diameter (D50) can be measured using widely known methods, such as a particle size analyzer, transmission electron microscope (TEM) imaging, or scanning electron microscope (SEM) imaging. Alternatively, dynamic light scattering may be used, where particle counts within size ranges are analyzed to calculate the average particle diameter (D50). Additionally, a laser scattering method may be employed, in which a target particle is dispersed in a solvent, introduced into a laser scattering particle measurement device (e.g., MT3000 from Microtrac, Inc.), irradiated with ultrasonic waves at 28 kHz and 60 W, and subsequently analyzed to determine the D50 value based on a 50% cumulative particle size distribution.

When the terms “about” or “substantially” are used in this specification in connection with a numerical value, it is intended that the associated numerical value include a tolerance of 10% around the stated numerical value. When ranges are specified, the range includes all values therebetween such as increments of 0.1%.

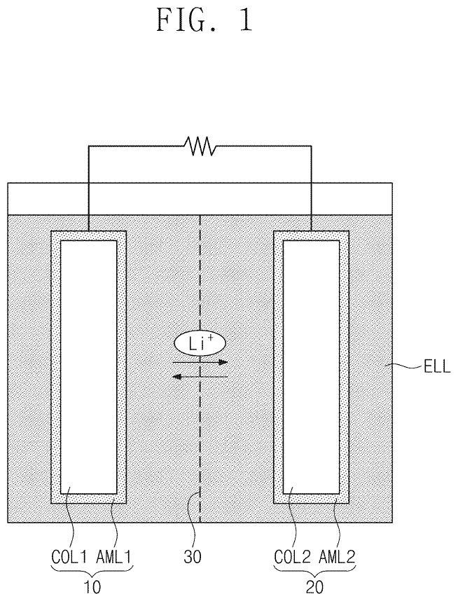

FIG. 1 is a simplified conceptual diagram illustrating a rechargeable lithium battery according to example embodiments of the present disclosure. Referring to FIG. 1, the rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material, and may further include a binder and/or a conductive material.

For example, the positive electrode 10 may further include an additive that can constitute a sacrificial positive electrode.

An amount of the positive electrode active material may be in a range of about 90 wt % to about 99.5 wt % relative to 100 wt % of the positive electrode active material layer AML1. An amount of each of the binder and the conductive material may be in a range of about 0.5 wt % to about 5 wt % relative to 100 wt % of the positive electrode active material layer AML1.

The binder may improve attachment of positive electrode active material particles to each other, and to improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material that does not cause a chemical change in a battery may be used as the conductive material to constitute the battery. The conductive material may include, for example, a carbon-based material such as at least one of natural graphite, artificial graphite, carbon black, acetylene black, Ketjen black, carbon fiber, carbon nano-fiber, and carbon nanotube; a metal powder or metal fiber containing one or more of copper, nickel, aluminum, and silver; a conductive polymer such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include a lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of the chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O₂₋ₐDₐ (where 0.90≤a≤1.8, 0≤b≤0.5, 0≤c≤0.5, and 0<α<2); LiₐNi_{1-b-c}Mn_{b}X_{c}O₂₋ₐDₐ (where 0.90≤a≤1.8, 0≤b≤0.5, 0≤c≤0.5, and 0<α<2); LiₐNi_{b}Co_{c}L¹_{d}GeO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90<a<1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity, and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material, and may further include a binder and/or a conductive material.

For example, the negative electrode active material layer AML2 may include a negative electrode active material at a concentration in a range of about 90 wt % to about 99 wt %, a binder at a concentration in a range of about 0.5 wt % to about 5 wt %, and a conductive material at a concentration in a range of about 0 wt % to about 5 wt %.

The binder may improve attachment of negative electrode active material particles to each other, and improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may provide an electrode with conductivity, and any suitable conductive material that does not cause chemical change to a battery may be used as the conductive material to constitute the battery. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative, or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or a transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as at least one of non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOₓ (where 0<x<2), Si-Q alloy (where Q is or includes at least one of alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) located on a surface of the secondary particle. The amorphous carbon may also be located between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer positioned on a surface of the core.

The Si-based negative electrode active material or the Sn-based negative electrode active material may be used in combination with a carbon-based negative electrode active material.

### Separator 30

Based on the type of rechargeable lithium battery, the separator 30 may be between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, or a combination thereof.

The porous substrate may be or include a polymer layer including a polyolefin having at least one of polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be configured as a stack including a coating layer including the organic material and a coating layer including an inorganic material.

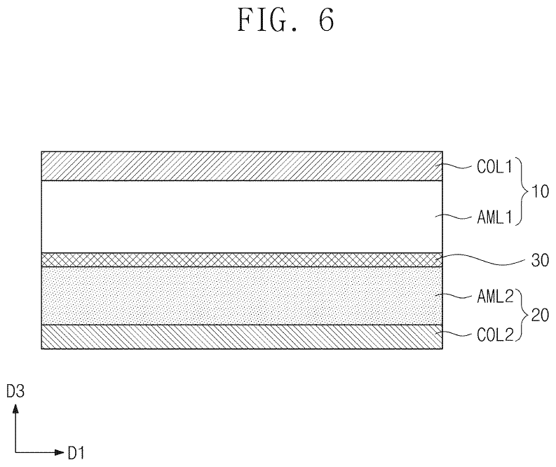

The negative electrode active material layer AML2 according to an example embodiment of the present disclosure is further discussed in detail with reference to FIGS. 6 to 8.

### Electrolyte ELL

The electrolyte ELL for a rechargeable lithium battery may include at least one of a non-aqueous organic solvent and a lithium salt. The non-aqueous organic solvent may constitute a medium for transmitting ions that participate in an electrochemical reaction of a battery. The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2,5-dimethyltetrahydrofuran, or tetrahydrofuran. The ketone-based solvent may include cyclohexanone. The alcohol-based solvent may include ethyl alcohol or isopropyl alcohol. The aprotic solvent may include at least one of nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1,4-dioxolane; or sulfolanes.

The non-aqueous organic solvent may be used alone, or in a mixture of two or more solvents.

In addition, when a carbonate-based solvent is used, a cyclic carbonate and a chain carbonate may be mixed, and the cyclic carbonate and the chain carbonate may be mixed in a volume ratio in a range of about 1:1 to about 1:9.

The lithium salt may be or include a material that is dissolved in the non-aqueous organic solvent to constitute a supply source of lithium ions in a battery and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluorobis(oxalato)phosphate (LiDFBOP), and lithium bis(oxalato)borate (LiBOB)

### Rechargeable Lithium Battery

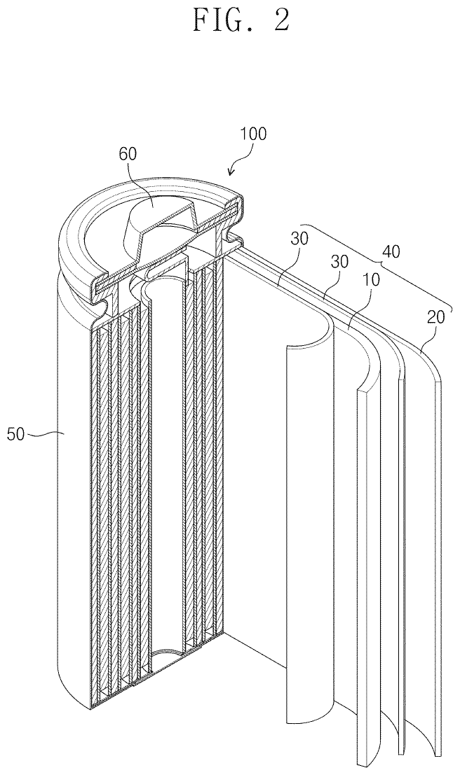

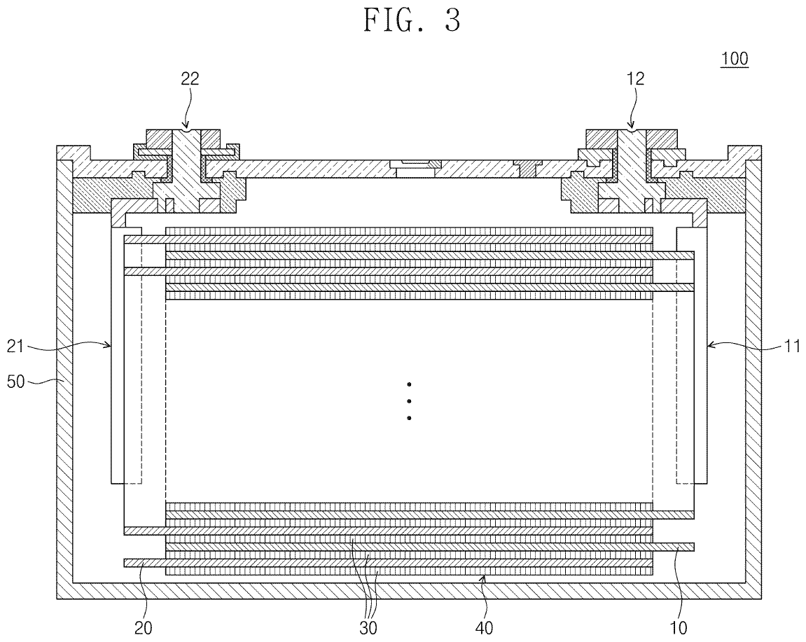

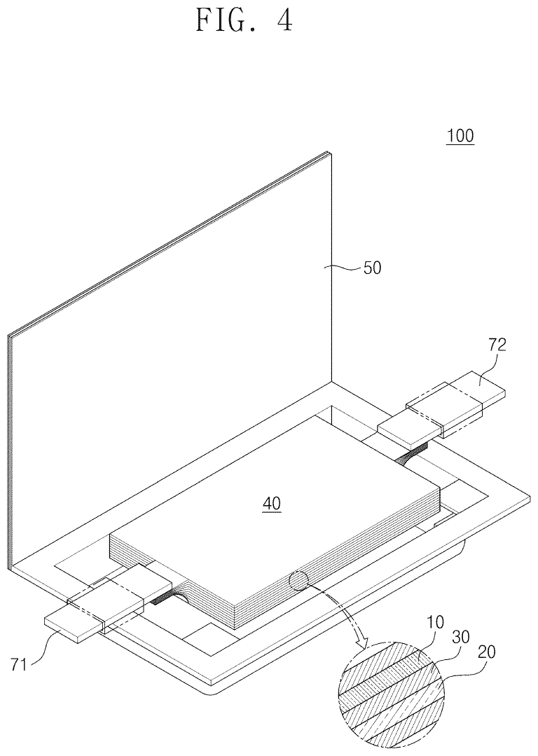

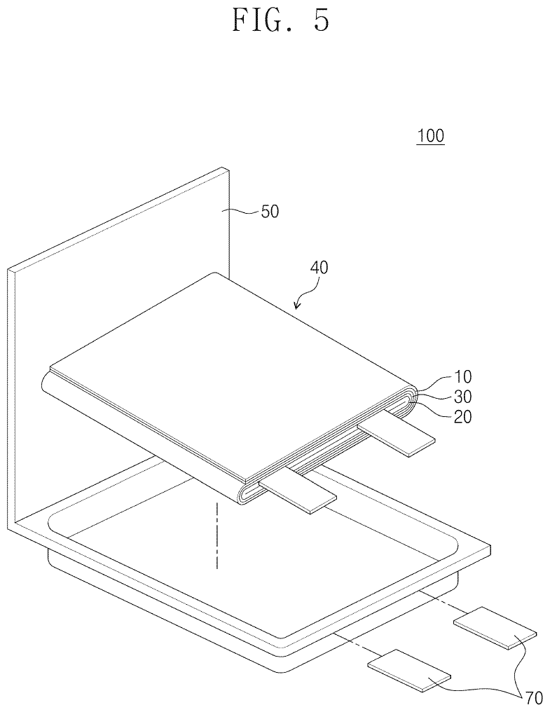

Based on the shape of a rechargeable lithium battery, the rechargeable lithium battery may be classified into cylindrical, prismatic, pouch, and coin types. In FIGS. 2 to 5 illustrating simplified diagrams showing a rechargeable lithium battery according to example embodiments, FIG. 2 shows a cylindrical battery, FIG. 3 shows a prismatic battery, and FIGS. 4 and 5 show pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tabs 70/71/72 constituting an electrical path for externally inducing a current generated in the electrode assembly 40 to outside of the battery 100.

The following description focuses on a rechargeable lithium battery according to example embodiments of the present disclosure.

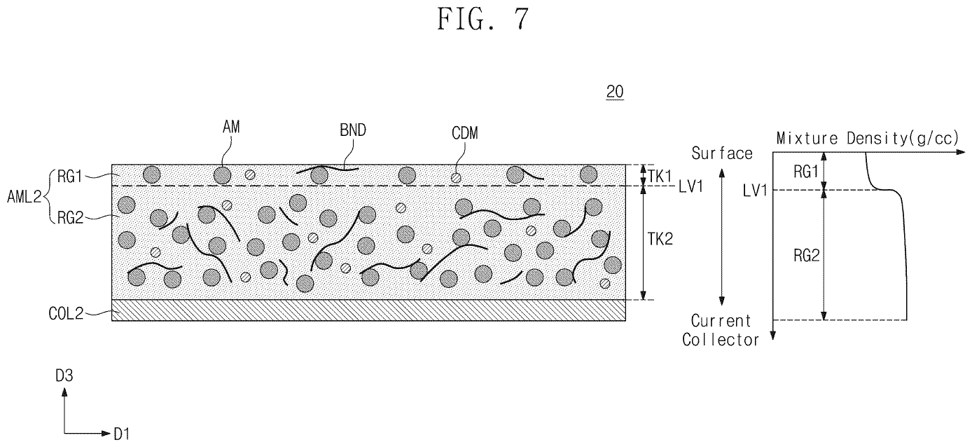

FIG. 6 is a cross-sectional view illustrating a rechargeable lithium battery according to example embodiments of the present disclosure. FIG. 7 is a cross-sectional view illustrating a negative electrode for a rechargeable lithium battery according to an example embodiment of the present disclosure.

Referring to FIG. 6, as described above with reference to FIG. 1, the rechargeable lithium battery according to the present disclosure may include a positive electrode 10, a negative electrode 20, and a separator 30 between the positive electrode 10 and the negative electrode 20. Although not clearly shown in FIG. 6, the rechargeable lithium battery according to the present disclosure may further include an electrolyte ELL. The separator 30 may be impregnated in the electrolyte ELL.

The positive electrode 10 may include a positive electrode current collector COL1, and a positive electrode active material layer AML1 on the positive electrode current collector COL1. The negative electrode 20 may include a negative electrode current collector COL2, and a negative electrode active material layer AML2 on the negative electrode current collector COL2. The separator 30 may be interposed between the positive electrode active material layer AML1 and the negative electrode active material layer AML2.

Referring to FIG. 7, the negative electrode active material layer AML2 according to example embodiments of the present disclosure may include a negative electrode active material AM and a binder BND. The negative electrode active material layer AML2 may further include a conductive material CDM.

The negative electrode active material AM may include a carbon-based active material, a Si-based active material or a Sn-based active material. The carbon-based material may include, for example, at least one of crystalline artificial graphite, crystalline natural graphite, amorphous hard carbon, low crystalline soft carbon, carbon black, acetylene black, Ketjen black, super P, graphene, and fibrous carbon. The Si-based material may include, for example, at least one of silicon, silicon-carbon composites, SiOₓ (0<x≤2), and Si-Q alloys (wherein Q is or includes at least one of alkali metals, alkaline earth metals, Group 13 elements, Group 14 elements (excluding Si), Group 15 elements, Group 16 elements, transition metals, rare earth elements, and a combination thereof). The Sn-based material may include at least one of Sn, SnO2, and a Sn-based alloy.

The binder BND may improve attachment of the negative electrode active material particles to each other, and improve attachment of the negative electrode active material to a current collector COL1. The binder BND may include a non-aqueous binder, an aqueous binder, a dry binder, or a combination thereof. The binder BND may include at least one of polyvinyl alcohol, carboxymethylcellulose, hydroxypropyl cellulose, diacetyl cellulose, polyvinyl chloride, carboxylated polyvinylchloride, polyvinylfluoride, a polymer containing ethylene oxide, polyvinyl pyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, and nylon, but the present disclosure is not limited thereto.

The conductive material CDM (e.g., an electrically conductive material) may provide an electrode with conductivity, and any suitable conductive material that does not cause a chemical change of a battery may be used as the conductive material. For example, the conductive material CDM may include carbon-based materials such as at least one of natural graphite, artificial graphite, carbon black, acetylene black, Ketjen black, carbon fiber, carbon nano fiber, and carbon nanotube; metal-based materials containing at least one of copper, nickel, aluminum, silver, and the like, in a form of metal powder or metal fiber; a conductive polymer such as polyphenylene derivatives; and a mixture thereof.

According to an example embodiment of the present disclosure, the negative electrode active material layer AML2 may include a first region RG1 adjacent to a surface of the negative electrode active material layer AML2, and a second region RG2 between the first region RG1 and the negative electrode current collector COL2.

The negative electrode active material layer AML2 may be formed through a process of applying a negative electrode slurry onto the negative electrode current collector COL2, followed by drying and rolling. The negative electrode slurry may include the negative electrode active material AM, the binder BND, and the conductive material CDM. Accordingly, each of the first and second regions RG1 and RG2 constituting the negative electrode active material layer AML2 may include the same type of negative electrode active material, binder, and conductive material.

As the surface treatment process described below is performed on the negative electrode active material layer AML2, differences in parameters such as a mixture density, a porosity, an amount of the binder, may occur within the negative electrode active material layer AML2.

For example, the negative electrode active material layer AML2 according to an example embodiment of the present disclosure may include first and second regions RG1 and RG2 having different mixture densities, porosities, and amounts of the binder. That is, as shown in FIG. 7, the negative electrode active material layer AML2 may have a difference such as a mixture density or the like based on the thickness direction. In addition, the negative electrode active material layer AML2 may have a single-layer structure in which an interface between the first and second regions RG1 and RG2 does not exist.

The thickness TK1 of the first region RG1 may be a depth from the surface of the negative electrode active material layer AML2 to a point having a specific mixture density. The specific mixture density may be in a range of about 0.7 times to about 0.95 times an average mixture density of the negative electrode active material layer AML2. For example, the specific mixture density may be in a range of about 0.8 times to about 0.95 times the average mixture density of the negative electrode active material layer AML2.

A point at which the first and second regions RG1 and RG2 are separated may be defined as a first level LV1. That is, the first level LV1 may be located at a point having a value in a range of about 0.7 times to about 0.95 times the average mixture density of the negative electrode active material layer AML2. There may be a sharp change in mixture density at the first level LV1 (i.e., a boundary between the first and second regions RG1 and RG2).

The average mixture density of the negative electrode active material layer AML2 may be substantially the same as a mixture density of the second region RG2, or the average mixture density of the negative electrode active material layer AML2 may be less than a mixture density of the second region RG2. This is because a portion of the first region RG1 in the negative electrode active material layer AML2 is relatively small, resulting in a negligible influence on the average mixture density of the negative electrode active material layer AML2.

For example, an average mixture density of the negative electrode active material layer AML2 may refer to a weighted average value considering a mixture density and a thickness of each of the first and second regions RG1 and RG2.

The thickness TK1 of the first region RG1 may be in a range of about 1 μm to about 20 μm. For example, the thickness TK1 of the first region RG1 may be about 1 μm to about 5 μm, about 3 μm to about 10 μm, about 7 μm to about 15 μm, about 12 μm to about 18 μm, or about 16 μm to about 20 μm.

The thickness TK2 of the second region RG2 may be in a range of about 40 μm to about 180 μm. For example, the thickness TK2 of the second region RG2 may be about 40 μm to about 70 μm, about 60 μm to about 100 μm, about 80 μm to about 120 μm, about 100 μm to about 150 μm, or about 140 μm to about 180 μm.

The thickness of the negative electrode active material layer AML2 may be in a range of about 50 μm to about 200 μm. For example, the thickness of the negative electrode active material layer AML2 may be about 50 μm to about 70 μm, about 80 μm to about 100 μm, about 120 μm to about 150 μm, about 140 μm to about 170 μm, or about 160 μm to about 200 μm. The thickness of the negative electrode active material layer AML2 may be a sum of the thickness TK1 of the first region RG1 and the thickness TK2 of the second region.

In the present disclosure, the term “thickness” may be measured, for example, through an image taken with an optical microscope such as, e.g., a scanning electron microscope (SEM).

Referring back to FIG. 7, as illustrated in the mixture density profile, the negative electrode active material layer AML2 may have a structure in which the mixture density increases from the surface toward the negative electrode current collector COL2. This is because the binder BND in the surface region of the negative electrode active material layer AML2 is removed as the surface treatment process described below is performed on the negative electrode active material layer AML2. That is, a distribution of the binder BND in the negative electrode active material layer AML2 may also have a concentration gradient in which an amount of binder increases from the surface toward the negative electrode current collector COL2. A specific form of the mixture density profile is not particularly limited, and for example, the mixture density of the negative electrode active material layer AML2 may decreases continuously or stepwise. For example, the mixture density may be constant or gradually increased in a thickness direction within each of the first and second regions RG1 and RG2. In this case, there may be a sharp change in mixture density at a boundary between the first and second regions RG1 and RG2. Accordingly, when an interface between the first and second regions RG1 and RG2 is not clearly distinguished, the interface may be inferred through the mixture density profile.

The mixture density profile can be determined according to the process conditions of a surface treatment process described below, and the like.

In an example embodiment, the mixture density of the first region RG1 may be less than the mixture density of the second region RG2. For example, a ratio of the mixture density of the first region RG1 to the mixture density of the second region RG2 may be in a range of about 0.7 to about 0.95.

The mixture density of the first region RG1 may be in a range of about 1.05 g/cc to about 1.6 g/cc. For example, the mixture density of the first region RG1 may be about 1.1 g/cc to about 1.3 g/cc, about 1.2 g/cc to about 1.4 g/cc, about 1.25 g/cc to about 1.55 g/cc, or about 1.3 g/cc to about 1.55 g/cc. When the mixture density of the first region RG1 satisfies the above-described range, lithium-ion mobility in the first region RG1 can be improved, thereby enhancing the electrolyte impregnation characteristics of the battery including the same, and reducing or preventing the generation of dendrites to improve the stability of the battery.

The mixture density of the second region RG2 may be in a range of about 1.35 g/cc to about 1.7 g/cc. For example, the mixture density of the second region RG2 may be about 1.4 g/cc to about 1.5 g/cc, about 1.45 g/cc to about 1.55 g/cc, or about 1.5 g/cc to about 1.65 g/cc. When the mixture density of the second region RG2 satisfies the above-described range, the capacity per volume of the battery including the same can be improved to achieve high capacity and high energy density.

In the present disclosure, the term “mixture density” refers to a mass per unit volume of an electrode material, and may include the electrode material in a solid state and voids in a space occupied by the electrode material. A high mixture density means that more electrode material is included under the same volume in constituting the electrode active material layer. The electrode material such as a negative electrode material may include a negative electrode active material, a binder, a conductive material, and the like. A method for measuring the mixture density is not particularly limited as long as the method is known in the art. The mixture density of the negative electrode active material layer AML2 may be measured using, for example, Surface And Interfacial Characterizing Analysis System (SAICAS), X-ray diffraction (XRD), focused ion beam electron scanning microscopy (FIB-SEM), time-of-flight secondary-ion mass spectrometry (TOF-SIMS), or the like.

As an example, the mixture density of the first region RG1 may be obtained by measuring a mass after cutting a specific volume in the first region RG1 using SAICAS. The volume cut out of the first region RG1 can be obtained by the product of the width of the SAICAS blade, the moving distance of the blade, and the cutting depth. Similarly, the mixture density of the second region RG2 can be obtained by measuring the mass after cutting a specific volume in the second region RG2 using SAICAS. The volume cut out from the second region RG2 can also be obtained by the product of the width of the SAICAS blade, the moving distance of the blade, and the cutting depth. In this case, in order to measure the mixture density in the second region RG2, it may be desirable to cut the first region RG1 in advance.

A ratio of the thickness TK1 of the first region RG1 to the thickness TK1+TK2 of the negative electrode active material layer AML2 may be in a range of about 0.01 to about 0.1. When the ratio of the thickness TK1 of the first region RG1 to the thickness TK1+TK2 of the negative electrode active material layer AML2 is less than about 0.01, the effect of improving the electrolyte impregnation characteristics and lithium-ion mobility may be insignificant. When the ratio of the thickness TK1 of the first region RG1 to the thickness TK1+TK2 of the negative electrode active material layer AML2 is greater than about 0.1, there may be a challenge in that the average mixture density of the negative electrode active material layer AML2 may be reduced, and the capacity per volume of the battery may be reduced.

In an example embodiment, an amount of the binder BND in the first region RG1 may be less than an amount of the binder BND in the second region RG2.

An amount of the binder BND in the first region RG1 may be greater than about 0 wt % and less than or equal to about 3 wt % relative to a total weight of the first region RG1. For example, an amount of the binder BND in the first region RG1 may be about 0.2 wt % to about 2.5 wt %, about 0.4 wt % to about 2.0 wt %, or about 0.6 wt % to about 1.5 wt %. When the amount of the binder BND in the first region RG1 satisfies the above range, it is possible to more effectively reduce or prevent an increase in the migration resistance of lithium ions.

An amount of the binder BND in the second region RG2 may be greater than about 0 wt % and less than or equal to about 7 wt % relative to a total weight of the second region RG2. For example, an amount of the binder BND in the second region RG2 may be about 2 wt % to about 6.5 wt %, about 2.5 wt % to about 6 wt %, or about 3 wt % to about 5.5 wt %. When an amount of the binder BND in the second region RG2 satisfies the above range, sufficient adhesive force with the negative electrode current collector COL2 can be secured.

In the present disclosure, the term “amount of the binder” may indicate a proportion of the weight of the binder BND in each region to a total weight of each region. The total weight of each region may be a total weight of electrode materials such as a negative electrode active material, a binder, and a conductive material contained in each region. For example, an amount of the binder BND in the first region RG1 may refer to a proportion of the binder BND to a total weight of the negative electrode active material AM, the binder BND, and the conductive material CDM in the first region RG1. In addition, an amount of the binder BND in the second region RG2 may refer to a proportion of the binder BND to a total weight of the negative electrode active material AM, the binder BND, and the conductive material CDM in the second region RG2. A method for measuring an amount of the binder is not particularly limited as long as it is a measurement method widely known in the art. For example, the binder BND can be measured using, e.g., thermogravimetric analysis (TGA), X-ray photoelectron spectroscopy (XPS), secondary-ion mass spectrometry (SIMS), or the like.

In an example embodiment, the binder BND in the first and second regions RG1 and RG2 may be measured by thermogravimetric analysis (TGA). For example, the upper layer (e.g., the first region RG1) and the lower layer (e.g., the second region RG2) can be separated by physically cutting the negative electrode active material layer AML2 from the surface of the negative electrode active material layer AML2 to a point having a specific depth in the direction toward the negative electrode current collector COL2. Afterwards, a change in mass when the binder decomposes can be measured for each of the upper and lower layers using a thermogravimetric analysis (TGA). In this case, the thermogravimetric analysis (TGA) can be measured at a temperature rising rate in a range of about 5° C./min to about 10° C./min under an atmospheric condition. Through this pyrolysis profile, the weight ratio (%) can be determined by weight loss.

In an example embodiment, a porosity of the first region RG1 may be greater than the porosity of the second region RG2. This is because a porosity is improved as the binder BND in the surface region of the negative electrode active material layer AML2 is removed through a surface treatment process described below.

A porosity of the first region RG1 may be in a range of about 40 vol % to about 60 vol %. A porosity of the first region RG1 may be, for example, about 42 vol % to about 48 vol %, about 46 vol % to about 54 vol %, or about 50 vol % to about 58 vol %. When a porosity of the first region RG1 satisfies the above range, an internal pore may have an a desired or improved buffering effect on volume expansion during charging and discharging.

A porosity of the second region RG2 may be in a range of about 10 vol % to about 30 vol %. A porosity of the second region RG2 may be, for example, about 12 vol % to about 18 vol %, about 16 vol % to about 24 vol %, or about 20 vol % to about 28 vol %. When a porosity of the second region RG2 satisfies the above range, the energy density may be improved by improving a capacity per volume of the battery.

In the present disclosure, the term “porosity” may indicate the ratio of the volume occupied by pores to a total volume of the electrode active material layer. The unit of porosity is vol %, and can be used interchangeably with terms such as pore fraction and void fraction. A method for measuring a porosity is not particularly limited as long as the measurement method is widely known in the art. A porosity of the negative electrode active material layer AML2 can be measured according to, for example, FIB-SEM, BET (Brunauer-Emmett-Teller) measurement method using nitrogen gas (N₂), mercury permeation method (Hg porosimeter), ASTM D-2873, or the like.

In an example embodiment, a porosity of the first region RG1 and the second region RG2 may be measured using focus ion beam-scanning electron microscopy (FIB-SEM). For example, the negative electrode active material layer AML2 may be physically cut from the surface to a point having a specific depth in a direction toward the negative electrode current collector COL2 to be separated into an upper layer (e.g., the first region RG1) and a lower layer (e.g., the second region RG2). Thereafter, each layer is cut with an ion beam (FIB), a cross-sectional SEM image is taken, and a porosity of each layer may be obtained by calculating the proportion of pores through image analysis.

That is, the negative electrode active material layer AML2 according to an example embodiment of the present disclosure, may include the first region RG1 having a relatively low mixture density and the second region RG2 having a relatively high mixture density. In addition, the negative electrode active material layer AML2 may include the first region RG1 having a relatively low amount of the binder BND and the second region RG2 having a relatively high amount of the binder BND. In addition, the negative electrode active material layer AML2 may include the first region RG1 having a relatively large porosity and the second region RG2 having a relatively small porosity.

As described above, the present disclosure may have a different mixture density, amount of binder, and porosity for each region in the negative electrode active material layer AML2. Accordingly, in the upper layer (e.g., the first region RG1), lithium-ion mobility can be improved, thereby enhancing the electrolyte impregnation characteristics and the high-rate characteristics of the battery. In addition, in the lower layer (e.g., the second region RG2), a high capacity and a high energy density can be achieved. That is, according to an example embodiment of the present disclosure, it is possible to implement a hybrid negative electrode that simultaneously or contemporaneously ensures not only improved capacity but also fast charging characteristics. The hybrid negative electrode may refer to a negative electrode capable of realizing high capacity and high output by including regions with different mixture densities, amounts of binder, porosities, and the like, within a single-layer negative electrode active material layer.

In the example embodiments of the present disclosure that follow, a detailed description of technical features repetitive to the negative electrode for the rechargeable lithium battery described above with reference to FIG. 7 is omitted, and differences thereof are described in detail.

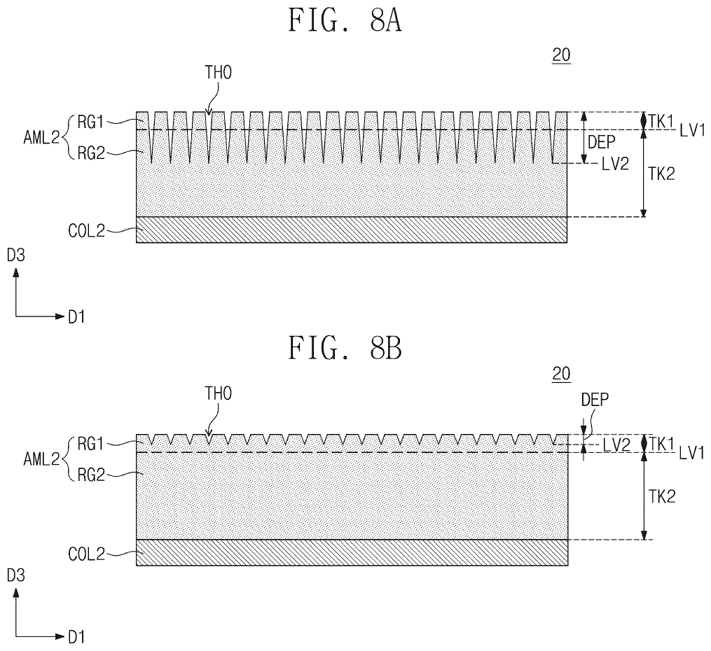

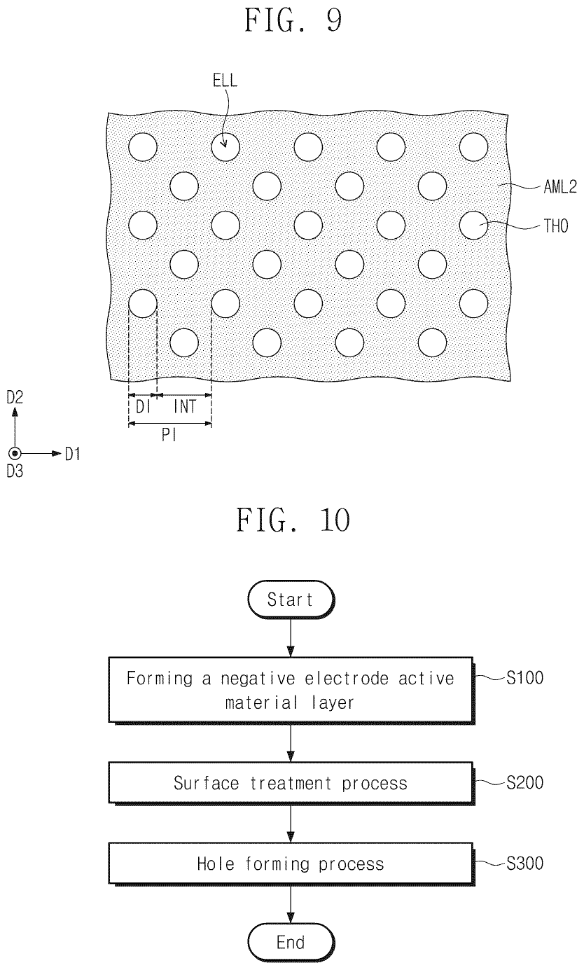

FIGS. 8A and 8B are cross-sectional views illustrating negative electrodes for a rechargeable lithium battery according to another example embodiment of the present disclosure. FIG. 9 is a plan view of a negative electrode active material layer according to another example embodiment of the present disclosure.

Referring to FIG. 8, the negative electrode active material layer AML2 may include a plurality of holes THO. The plurality of holes THO according to the present disclosure may be configured such that the negative electrode active material layer AML2 may be in contact with the electrolyte ELL. Accordingly, lithium-ion mobility and the electrolyte impregnation characteristics may be further improved through the plurality of holes THO formed in the negative electrode active material layer AML2. As a result, the rechargeable lithium battery according to an example embodiment of the present disclosure can have improved charge-discharge characteristics. In particular, the rapid charging characteristics and the electrolyte impregnation characteristics of the battery can be further improved.

The holes THO may have a first depth DEP. The first depth DEP may refer to an average depth of the holes THO.

A ratio of the first depth DEP to the thickness TK1+TK2 of the negative electrode active material layer AML2 may be in a range of about 0.05 to about 0.5. For example, the ratio of the first depth DEP to the thickness TK1+TK2 of the negative electrode active material layer AML2 may be about 0.05 to about 0.3, or about 0.05 to about 0.2. When the ratio of the first depth DEP to the thickness TK1+TK2 of the negative electrode active material layer AML2 exceeds the above range, the depth of the holes THO becomes excessively or substantially deep, which may cause a structural stability problem of the negative electrode active material layer AML2. In addition, the volume of the negative electrode active material layer AML2 is reduced by the holes THO, which may cause a decrease in a capacity of the negative electrode activity layer AML2. When the ratio of the first depth DEP to the thickness TK1+TK2 of the negative electrode active material layer AML2 is less than the above range, the effect of improving the movement speed of lithium ions in the negative electrode active material layer AML2 may be substantially insignificant, and an issue of poor rapid charging characteristics of the battery may occur. When the first depth DEP satisfies the above range, rapid charging characteristics and electrolyte impregnation characteristics can be further improved.

In an example embodiment, when a thickness of the negative electrode active material layer AML2 is considered, the holes THO may have a depth in a range of about 2.5 μm to about 120 km. Specifically, the depth of the holes may be about 5 μm to about 80 km. However, the present disclosure is not limited thereto, and the depth of the holes may be adjusted as desired according to the thickness of the negative electrode active material layer AML2.

As shown in FIGS. 8A and 8B, the bottom of the holes THO may be located at a second level LV2. The second level LV2 may be higher or lower than the above-described the first level LV1 with respect to the third direction D3. That is, the first depth DEP may be greater than, or less than, the thickness TK1 of the first region RG1. For example, referring to FIG. 8A, the first depth DEP may be greater than the thickness TK1 of the first region RG1. As another example, referring to FIG. 8B, the first depth DEP may be less than the thickness TK1 of the first region RG1. A ratio of the thickness TK1 of the first region RG1 to the first depth DEP may be in a range of 0.1 to 3.

When the ratio of the thickness TK1 of the first region RG1 to the first depth DEP satisfies the above range, the volume reduction due to the holes is not large, so that lithium-ion mobility is further improved while achieving a high capacity, and the effect of improving rate characteristics and electrolyte impregnation characteristics may be further improved or maximized.

Referring to FIG. 9, the holes THO may be arranged at a first pitch PI in a first direction D1. Each of the holes THO may have a first diameter DI. The first diameter DI may refer to an average diameter of the holes THO. A separation interval between adjacent holes THO may be a first distance INT. The first pitch PI may be a sum of the first diameter DI and the first distance INT. For example, the first distance INT may be greater than the first diameter DI.

In an example embodiment, a ratio (DI/PI) of the first diameter DI to the first pitch PI may be in a range of 0.1 to 0.4. When the ratio (DI/PI) is less than the above range, the depth DEP of the hole THO may not be formed sufficiently deep so that the electrolyte may sufficiently penetrate into the negative electrode active material layer AML2. When the ratio (DI/PI) exceeds the above range, the size of the holes THO becomes excessively or substantially large, which may cause a problem in structural stability of the negative electrode active material layer AML2. In addition, the volume of the negative electrode active material layer AML2 is reduced due to the holes THO, which may cause a decrease in a capacity of the battery.

The first pitch PI may be in a range of about 50 μm to about 100 μm. The first pitch PI may be, for example, about 60 μm to about 75 μm, about 65 μm to about 80 μm, about 70 μm to about 85 μm, or about 75 μm to about 90 μm. When the pitch of the holes THO satisfies the above range, rapid charging characteristics may be further improved.

The first diameter DI may be in a range of about 5 μm to about 40 μm. The first diameter DI may be, for example, about 10 μm to about 20 μm, about 15 μm to about 25 μm, about 20 μm to about 30 μm, or about 25 μm to about 35 μm. When the average diameter of the holes THO satisfies the above range, it is possible to further improve rapid charge and discharge characteristics while maintaining a capacity of the battery and a strength of the negative electrode active material layer AML2.

The density of the holes THO may be in a range of about 50 pt/mm² to about 500 pt/mm². The density of the holes THO may be, for example, about 60 pt/mm² to about 120 pt/mm², about 100 pt/mm² to about 250 pt/mm², about 200 pt/mm² to about 350 pt/mm², or about 300 pt/mm² to about 450 pt/mm². When the density of the holes THO satisfies the above range, it is possible to further improve rapid charge and discharge characteristics while maintaining a capacity of the battery and a strength of the negative electrode active material layer AML2. In the present disclosure, the term “density” may indicate the number of holes (pt) per unit area (mm²).

FIG. 9 illustrates a case where the holes THO are regularly arranged and have a substantially circular planar shape. However, an arrangement and a planar shape of the hole THO are not limited to the shapes illustrated in FIG. 9. For example, a planar shape of the hole THO may be an ellipse or a polygon. The holes THO may have an irregularly arranged shape.

According to the present example embodiment, a volume reduction of the negative electrode active material layer AML2 due to the plurality of holes THO may not be large. That is, the holes THO formed in the negative electrode active material layer AML2 may significantly improve a charging and discharging speed of the battery, but may not significantly reduce a capacity of the battery.

The negative electrode for the rechargeable lithium battery according to the present example embodiment can further improve rapid charging and discharging characteristics and electrolyte impregnation characteristics by including a plurality of holes of an appropriate or desired size and depth. This is because a diffusion path of lithium ions can be widened and shortened through the holes configured to be in contact with the negative electrode active material layer AML2 and the electrolyte, thereby improving a moving speed of lithium ions.

In addition, the negative electrode for a rechargeable lithium battery according to the present example embodiment may have a mixture density, an amount of the binder, or a porosity in the first and second regions RG1 and RG2 that are substantially the same as the mixture density, amount of the binder, and porosity described above with reference to FIG. 7. In the present disclosure, substantially the same may means that a difference between the mixture density, amount of binder, and porosity is within a range of about 10% or about 5%.

### Method for Manufacturing a Negative Electrode

The following description focuses on a method for manufacturing a negative electrode for a rechargeable lithium battery, according to an example embodiment of the present disclosure.

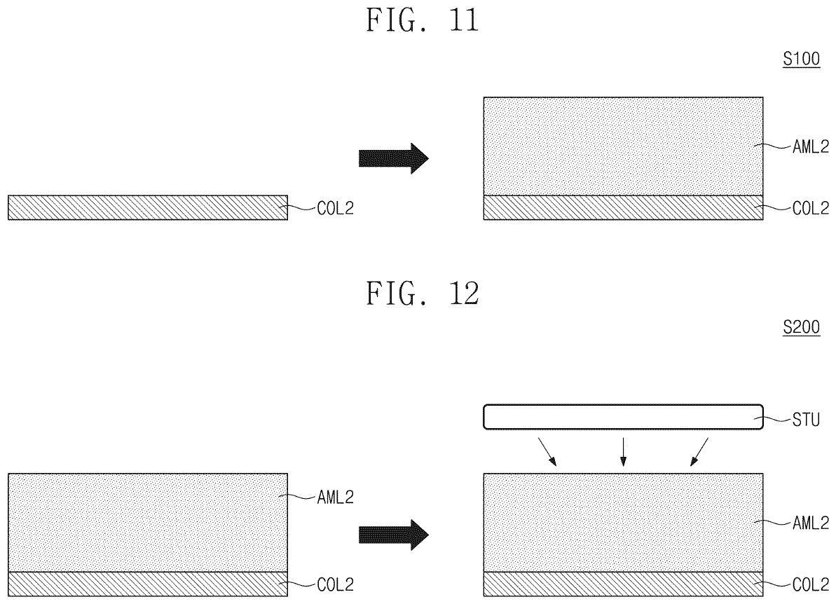

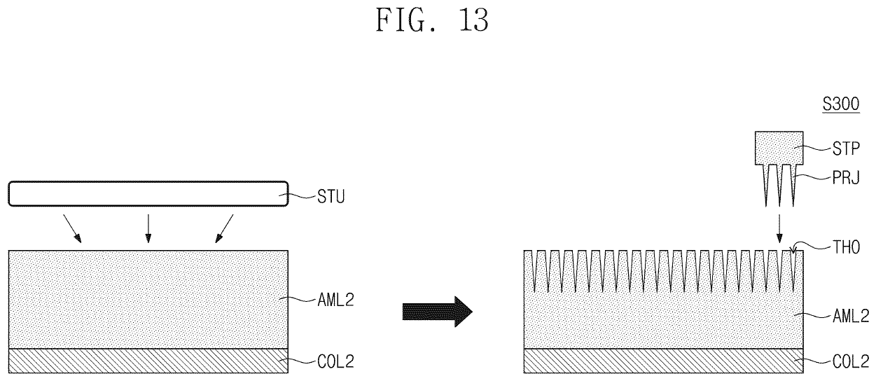

FIG. 10 is a flowchart illustrating a method for manufacturing a negative electrode for a rechargeable lithium battery, according to an example embodiment of the present disclosure. FIG. 11 is a diagram illustrating step S100 of FIG. 10. FIG. 12 is a diagram illustrating step S200 of FIG. 10. FIG. 13 is a diagram illustrating step S300 of FIG. 10.

Referring to FIG. 10, a method of manufacturing a negative electrode for a rechargeable lithium battery according to an example embodiment of the present disclosure may include forming a negative electrode active material layer including a negative active material and a binder on a negative electrode current collector (S100), performing a surface treatment process on the negative electrode active material layer to remove the binder in a surface region of the negative electrode active material layer (S200), and performing a hole-forming process on the negative electrode active material layer on which the surface treatment process has been performed to form a plurality of holes (S300).

Referring to FIG. 11, forming a negative electrode active material layer S100 may include coating a negative electrode slurry onto the negative electrode current collector COL2, and drying and rolling the negative electrode slurry.

For example, the negative electrode slurry may be coated onto the negative electrode current collector COL2. The negative electrode slurry may include a negative electrode active material, a binder, and a solvent (e.g., organic solvent). The negative electrode slurry may further include a conductive material as necessary. In a preparation of the negative electrode slurry, the negative electrode active material and the binder are added to the organic solvent, and the resulting mixture is stirred to prepare the negative electrode slurry.

The organic solvent may be or include a solvent commonly used in the art. The organic solvent may include, for example, at least one of dimethyl sulfoxide (DMSO), isopropyl alcohol, N-methyl pyrrolidone (NMP), acetone, water, and a combination thereof.

The prepared negative electrode slurry may then be coated onto the negative electrode current collector COL2 at, e.g., a constant thickness. A coating method is not particularly limited, for example, a doctor blade, a slot die coater, or the like coating equipment can be used.

The negative electrode slurry may then be dried and rolled. After the negative electrode slurry is coated, the negative electrode slurry may be dried to remove the solvent. Thus, the negative electrode active material layer AML2 in a solid state can be formed. Drying conditions such as temperature and time can be adjusted as desired according to a composition of the negative electrode active material layer AML2. However, in the present disclosure, in forming the negative electrode active material layer AML2, a dry process that does not involve the organic solvent may be applied in addition to the wet process as described above.

Thereafter, the dried negative electrode active material layer AML2 may be rolled to have a constant thickness and density. In this case, characteristics such as porosity and mixture density of the negative electrode active material layer AML2 may be adjusted through a rolling process. Thus, the negative electrode active material layer AML2 can be formed on the negative electrode current collector COL2.

In general, in the drying process of the negative electrode slurry described above, a migration phenomenon in which the binder moves to the surface of the negative electrode active material layer AML2 due to a flow of the solvent, resulting in a concentration of the binder increases in the surface region. As a result, problems such as an increase in an internal resistance of the battery, and a significant decrease in charge-discharge characteristics may occur.

Referring to FIG. 12, according to an example embodiment of the present disclosure, the binder in the surface region of the negative electrode active material layer AML2 may be removed by performing a surface treatment process S200 on the negative electrode active material layer AML2. That is, the binder present in the surface region of the negative electrode active material layer AML2 may be selectively removed through the surface treatment process S200. In other words, by maintaining a desired amount of the binder in an internal region of the negative electrode active material layer AML2, it is possible to achieve an improved or optimal level of cohesion among the components and adhesion between the negative electrode active material layer AML2 and the negative electrode current collector COL2. In the surface region, by removing the binder that acts as a resistor, the internal resistance of the battery can be reduced or minimized, thereby further improving the high-rate performance.

The negative electrode active material layer AML2 according to an example embodiment of the present disclosure may include a surface region adjacent to a surface of the negative electrode active material layer AML2 and an internal region between the surface region and the negative electrode current collector COL2.

The surface region is a region from which the binder is removed through the surface treatment process S200, and may be a region corresponding to the above-described first region. The internal region may be a region corresponding to the above-described second region. For example, in the negative electrode active material layer AML2, a region from the surface thereof to a point corresponding to about 70% to about 95% of the average mixture density of the negative electrode active material layer AML2 may be defined as a surface region, and a remaining region between the negative electrode current collector and the surface region may be defined as an internal region.

The surface region may be defined as a region extending to a predetermined or desired depth from a surface of the negative electrode active material layer in a direction of the negative electrode current collector. The predetermined or desired depth is less than or equal to about 10% of a thickness of the negative electrode active material layer AML2 in the direction of the negative electrode current collector COL2 from a surface of the negative electrode active material layer AML2. For example, the surface region may be less than or equal to about 8%, about 6%, or about 4% of a thickness of the negative electrode active material layer AML2.

In one example embodiment, a mixture density of the surface region may be less than a mixture density of the internal region. A ratio of a mixture density of the surface region to a mixture density of internal region may be in a range of about 0.7 to about 0.95.

A mixture density of the surface region may be in a range of about 1.05 g/cc to about 1.6 g/cc. A mixture density of the surface region may be, for example, about 1.1 g/cc to about 1.3 g/cc, about 1.2 g/cc to about 1.4 g/cc, about 1.25 g/cc to about 1.55 g/cc, or about 1.3 g/cc to about 1.55 g/cc.

A mixture density of the internal region may be in a range of about 1.35 g/cc to about 1.7 g/cc. A mixture density of the internal region may be, for example, about 1.4 g/cc to about 1.5 g/cc, about 1.45 g/cc to about 1.55 g/cc, or about 1.5 g/cc to about 1.65 g/cc.

In one example embodiment, an amount of the binder in the surface region may be less than an amount of the binder in the internal region.

An amount of binder in the surface region may be greater than about 0 wt % and less than or equal to about 3 wt % relative to a total weight of the surface region. An amount of the binder in the surface region may be, for example, about 0.2 wt % to about 2.5 wt %, about 0.4 wt % to about 2.0 wt %, or about 0.6 wt % to about 1.5 wt %.

An amount of binder in the internal region may be greater than about 0 wt % and less than or equal to about 7 wt % relative to a total weight of the internal region. An amount of the binder in the internal region may be, for example, about 2 wt % to about 6.5 wt %, about 2.5 wt % to about 6 wt %, or about 3 wt % to about 5.5 wt %.

In one example embodiment, a porosity of the surface region may be greater than a porosity of the internal region.

A porosity of the surface region may be in a range of about 40 vol % to about 60 vol %. A porosity of the surface region may be, for example, about 42 vol % to about 48 vol %, about 46 vol % to about 54 vol %, or about 50 vol % to about 58 vol %.

A porosity of the internal region may be in a range of about 10 vol % to about 30 vol %. A porosity of the internal region may be, for example, about 12 vol % to about 18 vol %, about 16 vol % to about 24 vol %, or about 20 vol % to about 28 vol %.

The surface treatment process S200 may be performed to remove the binder in the surface region of the negative electrode active material layer. The surface treatment process S200 may be performed by, e.g., at least one of light irradiation, heat treatment, or plasma treatment. In an example embodiment, the surface treatment process S200 may be performed by light irradiation. However, the surface treatment method is not particularly limited as long as the surface treatment method is a method widely known in the art.

As shown in FIG. 12, the surface treatment process S200 may be performed by light irradiation through the surface treatment unit STU. As an example, the surface treatment unit STU may be a flash lamp, but is not limited thereto. The surface treatment process S200 may be continuously performed via a process line for manufacturing a negative electrode.

In an example embodiment, the surface treatment process S200 by a flash lamp may be performed by irradiating light toward the upper portion of the negative electrode active material layer AML2. For example, a wavelength range of the flash lamp may be in a range of about 200 nm to about 1500 nm, including an entire range from infrared light to ultraviolet light. For example, an irradiation time of the flash lamp may be in a range of about 0.05 ms to about 10 ms, and an irradiation energy intensity may be in a range of about 0.5 J/cm² to about 50 J/cm².

The binder in the surface region of the negative electrode active material layer AML2 may be selectively oxidized and removed by using the above-described flash lamp. For example, a C—C bond of the binder is broken by applying high energy through flash lamp irradiation, so that the binder can be decomposed into a low-molecular-weight volatile compound and evaporated, or oxidized into CO₂ or moisture. That is, a light energy of the flash lamp may be greater than the binding energy of the binder.

A method of manufacturing the negative electrode according to an example embodiment of the present disclosure, may further include a post-treatment process after the surface treatment process S200 to remove residues. This is because solid carbonized residues may remain in a process of decomposition of the binder in the surface region during light irradiation by the flash lamp. That is, the post-treatment process may use, for example, scraping, brushing, high-pressure washing, laser cleaning, or the like.

Part of the binder in the surface region may be removed through the surface treatment process S200. In the present disclosure, the partial removal of the binder may refer to the removal of about 30% or more, for example about 50% or more, of the initial amount of the binder in the surface region before surface treatment.

Next, referring to FIG. 13, a hole formation process S300 may be performed on the negative electrode active material layer AML2 to form a plurality of holes THO. That is, a plurality of holes THO may be formed on the negative electrode active material layer AML2 through the hole forming process S300.

The holes THO may be arranged at a pitch in a range of about 50 μm to about 100 μm. The pitch of the holes THO may be, for example, about 60 μm to about 75 μm, about 65 μm to about 80 μm, about 70 μm to about 85 μm, or about 75 μm to about 90 μm.

The holes THO may have an average diameter in a range of about 5 μm to about 40 μm. The average diameter of the holes THO may be, for example, about 10 μm to about 20 μm, about 15 μm to about 25 μm, about 20 μm to about 30 μm, or about 25 μm to about 35 μm.

The holes THO may have a hole density in a range of about 50 to about 500 pt/mm². The density of the holes THO may be, for example, about 60 pt/mm² to about 120 pt/mm², about 100 pt/mm² to about 250 pt/mm², about 200 pt/mm² to about 350 pt/mm², or about 300 pt/mm² to about 450 pt/mm².

The hole forming process S300 may be performed using, e.g., at least one of a laser, a stamp, or a roller. In an example embodiment, the hole forming process S300 may be performed by using a stamp. However, a hole forming method is not particularly limited, and may be determined by considering various factors such as, e.g., a degree of detachment of the negative electrode active material, an extent of side reaction, a shape of the hole, and a processing speed. Depending on these considerations, an appropriate or desired processing method may be determined from, e.g., laser processing, stamping, or rolling.

As illustrated in FIG. 13, the holes THO may be physically formed through the stamp STP having a plurality of fine protrusions PRJ. A plurality of holes THO may be formed in an upper portion of the negative electrode while the negative electrode is continuously moved in one direction. Each of the plurality of the protrusions PRJ of the stamp STP may have at least one shape of a cone, a pyramid, a cylinder, or a prism, but is not limited thereto.

After the above-described the hole forming process S300 is performed, a mixture density, an amount of binder, or a porosity of each of the surface region and the internal region may be substantially the same as the mixture density, amount of binder, and porosity described above with reference to FIG. 12. In the present disclosure, “substantially the same” refers to difference within about 10% or about 5% among these parameters (e.g., mixture density, binder content, or porosity).

Afterward, the negative electrode may undergo (e.g., sequentially undergo) at least one of a roll-pressing process, a slitting process, and a notching process. A rechargeable lithium battery according to an example embodiment of the present disclosure can be manufactured by interposing a separator between a positive electrode and the negative electrode manufactured according to the above-described method for manufacturing the negative electrode, injecting an electrolyte, and then sealing an assembly.

In general, when the surface treatment process S200 is performed on the negative electrode active material layer AML2, a thickness of the negative electrode active material layer AML2 may increase as the binder in the surface region is removed. This is because, as the binder is removed, particles in the surface region may be rearranged, or spaces between the particles may be widened, thereby increasing a porosity in the surface region, and consequently increasing a thickness of the negative electrode active material layer AML2.

According to an example embodiment of the present disclosure, the hole forming process S300 may be performed after the surface treatment process S200 is performed on the negative electrode active material layer AML2, thereby improving the above-described problem. Thus, a desired performance of the battery can be achieved through the above-described manufacturing processes. That is, a thickness increased through the surface treatment process S200 can be compensated for by pressing through the hole forming process S300 that physically applies pressure through a stamp or the like as described above, thereby reducing or minimizing a decrease in capacity per volume of the battery.

In contrast, when the surface treatment step S200 is performed after the hole forming process S300 on the negative electrode active material layer AML2, as described above, even when a phenomenon in which a thickness of the negative electrode active material layer AML2 increases due to the surface treatment process S200 occurs, an effect of reducing or preventing a thickness increase of the negative electrode actively material layer AML2 through the hole forming process S300 may be difficult to achieve, and thus the capacity per volume may be further greatly reduced.

However, as described above, a process in which the hole forming process S300 is performed after the surface treatment process S200 on the negative electrode active material layer AML2 has been described, but the present disclosure is not limited thereto. In another example embodiment, only the surface treatment process S200 is performed on the negative electrode active material layer AML2, and the above-described hole forming process S300 may be omitted.

The negative electrode according to example embodiments of the present disclosure, may not have an interface between the surface region and the internal region, unlike a negative electrode of a multilayer structure, by selectively removing the binder in the surface region. Accordingly, since no interface exists between these regions, various issues such as, e.g., the existence of contact resistance, may not occur.

The following describes example embodiments and comparative examples of the present disclosure. However, the following example embodiments provided below are only examples of the present disclosure, and example embodiments of the present disclosure are not limited to the following examples.

### Embodiment 1

### Manufacture of Negative Electrode:

A negative electrode slurry was prepared by mixing 85.5 wt % of artificial graphite and 10 wt % of silicon carbon composite, 1.0 wt % of carboxymethyl cellulose and 1.5 wt % of styrene-butadiene rubber and 2 wt % of carbon black in pure water.

The prepared negative electrode slurry was coated onto a copper current collector, and then the slurry was dried and rolled to form a negative electrode active material layer having a total thickness of 100 μm. A mixture density of the negative electrode active material layer was 1.6 g/cc.

Next, a surface treatment process was performed on the negative electrode active material layer to remove the binder in a surface region of the negative electrode active material layer. In the surface treatment process, a light irradiation was performed using a flash lamp (Xenon Flash Lamp, manufactured by Pulseforge) under the following conditions.

Light irradiation time: 0.2 ms

Light irradiation energy: 1.0 J/cm²

In the final negative electrode active material layer, a region from a surface of the negative electrode active material layer to a point corresponding to about 95% with respect to an average mixture density of the negative electrode active material layer was defined as a first region, and a remaining region between the negative electrode current collector and the first region was defined as a second region.

### Manufacture of Half-Cell:

Using the negative electrode, the lithium metal as a counter electrode, and an electrolyte, a half-cell was manufactured by a conventional method. The electrolyte was prepared by using ethylene carbonate, ethyl methyl carbonate, and dimethyl carbonate (30:50:20 volume ratio) in which 1.5 M LiPF₆ was dissolved.

### Embodiment 2

A negative electrode was prepared in the same manner as in Example 1, with a difference that the light irradiation energy was 1.5 J/cm².

In the final negative electrode active material layer, a region from the surface of the negative electrode active material layer to a point corresponding to about 90% with respect to an average mixture density of the negative electrode activity layer was defined as a first region, and a remaining region between the negative electrode current collector and the first region was defined as a second region.

A half-cell was manufactured in the same manner as in Example 1, with a difference that the negative electrode was used.

### Embodiment 3

A negative electrode was prepared in the same manner as in Example 1, with a difference that the light irradiation energy was 2.2 J/cm².

In the final negative electrode active material layer, a region from the surface of the negative electrode active material layers to a point corresponding to about 84% with respect to an average mixture density of the negative electrode activity layer was defined as a first region, and a remaining region between the negative electrode current collector and the first region was defined as a second region.

A half-cell was manufactured in the same manner as in Example 1, with a difference that the negative electrode was used.

### Embodiment 4

### Manufacture of Negative Electrode:

A negative electrode slurry of Example 1 was coated onto a copper current collector, and then dried and rolled to form a negative electrode active material layer having a total thickness of 100 μm. A mixture density of the negative electrode active material layer was 1.6 g/cc.

Next, a surface treatment process was performed on the negative electrode active material layer to remove the binder in a surface region of the negative electrode active material layer. The surface treatment process was performed using a flash lamp. In this case, the surface treatment process conditions are the same as those in Example 3.

In the final negative electrode active material layer, a region from the surface of the negative electrode active material layer to a point corresponding to about 83% with respect to an average mixture density of the negative electrode active material layer was defined as a first region, and a remaining region between the negative electrode current collector and the first region was defined as a second region.

Next, a hole forming process was performed on the negative electrode active material layer to form a plurality of holes in the upper portion of the negative electrode active material layer. The hole forming process was performed using a stamp having a plurality of protrusions formed thereon. The holes were formed to have a depth of 5 μm, a diameter of 20 μm, a pitch of 50 μm, and a hole density of 400 pt/mm².

### Manufacture of Half-Cell:

Using the negative electrode, the lithium metal as a counter electrode, and an electrolyte, a half battery was manufactured by a conventional method. The electrolyte was prepared by using ethylene carbonate, ethyl methyl carbonate, and dimethyl carbonate (30:50:20 volume ratio) in which 1.5 M LiPF₆ was dissolved.

### Embodiment 5

A negative electrode and a half-cell were manufactured in the same manner as in Example 4, with a difference that the holes were formed to have a depth of 20 μm.

### Comparative Example 1

A negative electrode and a half-cell were manufactured in the same manner as in Example 1, with a difference that the surface treatment process was omitted and a mixture density of the negative electrode active material layer was 2.0 g/cc.

### Comparative Example 2

A negative electrode and a half-cell were manufactured in the same manner as in Example 1, with a difference that the surface treatment process was omitted and a mixture density of the negative electrode active material layer was 1.2 g/cc.

### Comparative Example 3

A negative electrode and a half-cell were manufactured in the same manner as in Example 4, with a difference that the surface treatment step process omitted.

### Comparative Example 4

A negative electrode and a halfcell were manufactured in the same manner as in Example 4, with a difference that the hole forming process was performed first on the negative electrode active material layer, followed by the surface treatment process.

Battery configurations according to Embodiments 1 to 5 and Comparative Examples 1 to 4 are shown in Table 1 and Table 2 below.

TABLE 1

| | | | Hole | Hole | Hole | Hole |
|---|---|---|---|---|---|---|
| | | Presence of | depth | diameter | pitch | density |
| | | hole or not | (μm) | (μm) | (μm) | (pt/mm²) |
| Embodiment 1 | First Region | no | | | | |
| | Second Region | | | | | |
| Embodiment 2 | First Region | no | | | | |
| | Second Region | | | | | |
| Embodiment 3 | First Region | no | | | | |
| | Second Region | | | | | |
| Embodiment 4 | First Region | yes | 5 | 20 | 50 | 400 |
| | Second Region | | | | | |
| Embodiment 5 | First Region | yes | 20 | 20 | 50 | 400 |
| | Second Region | | | | | |
| Comparative | | no | | | | |
| Example 1 | | | | | | |
| Comparative | | no | | | | |
| Example 2 | | | | | | |
| Comparative | | yes | 5 | 20 | 50 | 400 |
| Example 3 | | | | | | |
| Comparative | First Region | yes | 5 | 20 | 50 | 400 |
| Example 4 | Second Region | | | | | |

TABLE 2

| | | Thickness | Mixture density | | Porosity |
|---|---|---|---|---|---|
| | | (μm) | (g/cc) | | (vol %) |
| Embodiment 1 | First Region | 3 | 1.50 | 1.59 | 40 |
| | Second | 97 | 1.59 | | 15 |
| | Region | | | | |
| Embodiment 2 | First Region | 6 | 1.41 | 1.56 | 45 |
| | Second | 94 | 1.57 | | 19 |
| | Region | | | | |
| Embodiment 3 | First Region | 10 | 1.28 | 1.52 | 51 |
| | Second | 90 | 1.55 | | 24 |
| | Region | | | | |
| Embodiment 4 | First Region | 10 | 1.3 | 1.57 | 50 |
| | Second | 90 | 1.6 | | 20 |
| | Region | | | | |
| Embodiment 5 | First Region | 10 | 1.3 | 1.57 | 50 |
| | Second | 90 | 1.6 | | 20 |
| | Region | | | | |
| Comparative | | 100 | 2.0 | | 10 |
| Example 1 | | | | | |
| Comparative | | 100 | 1.2 | | 55 |
| Example 2 | | | | | |
| Comparative | | 100 | 1.57 | | 22 |
| Example 3 | | | | | |
| Comparative | First Region | 10 | 1.2 | 1.56 | 55 |
| Example 4 | Second | 90 | 1.6 | | 20 |
| | Region | | | | |

For reference, “Mixture density” in Table 2 above indicates the mass per volume of the negative electrode active material layer (a negative electrode active material, a binder, a conductive material, and the like) in each region of the negative electrodes manufactured according to the embodiments and the comparative examples.

### Evaluation Example 1: Evaluation of Electrochemical Properties

The half-cells prepared according to Embodiments 1 to 5 and Comparative Examples 1 to 4 were subjected to 0.2 C, 0.01 V cut-off charging under constant current conditions, 0.05 C cut-off charging at constant voltage conditions, and 0.2 C, 1.5 V cut-off discharging at constant current conditions. At this time, the discharge capacity during one charge and discharge was determined, and the specific capacity of the half battery was calculated, and the results are shown in Table 3 below.

The half-cells prepared according to Examples 1 to 5 and Comparative Examples 1 to 4 were subjected to constant-current charging at a current of 0.2 C to a voltage of 4.4 V, and constant-voltage charging while maintaining 4.4 V until the current reached 0.025 C. The battery subjected to constant-voltage charging was subjected to constant-current discharge at 0.2 C, 0.5 C, 1.0 C, and 2.0 C until reaching 2.75 V, and then the discharge capacity at 2.0 C relative to the discharge capacity at C-rate of 0.2 C was calculated, and the results are shown as rate characteristics (%) in Table 3 below.

TABLE 3

| | Specific capacity | Rate characteristics |
|---|---|---|
| | (mAh/g) | (%) |
| Embodiment 1 | 7.72 | 93.01 |
| Embodiment 2 | 7.97 | 96.02 |
| Embodiment 3 | 8.09 | 97.47 |
| Embodiment 4 | 8.22 | 98.19 |
| Embodiment 5 | 8.15 | 99.04 |
| Comparative Example 1 | 7.58 | 91.33 |
| Comparative Example 2 | 8.20 | 98.80 |
| Comparative Example 3 | 8.01 | 96.51 |
| Comparative Example 4 | 8.12 | 97.83 |

### Evaluation Example 2: Evaluation of Electrolyte Impregnation Property

For the half cells prepared according to Examples 1 to 5 and Comparative Examples 1 to 4, the measurement was performed in such a manner that 1 μl of a drop of the electrolyte was dropped on the suspension electrode, and the time point at which the contact angle became 0 was recorded. A polar plate having a size of 2 cm×2 cm was cut out, drops of the electrolyte were dropped on the surface, and the time was measured by a quantitative method, and the results are shown in Table 4 below.

TABLE 4

| | Impregnation time |
|---|---|
| | (s) |
| Embodiment 1 | 196 |
| Embodiment 2 | 170 |
| Embodiment 3 | 120 |
| Embodiment 4 | 110 |
| Embodiment 5 | 85 |
| Comparative Example 1 | 270 |
| Comparative Example 2 | 97 |
| Comparative Example 3 | 165 |
| Comparative Example 4 | 118 |

Referring to Tables 3 and 4, in the case of the negative electrode of Comparative Example 1, which has a relative high mixture density, the negative electrode of Comparative Example 1 exhibits a high capacity per volume but shows poor rate characteristics and electrolyte impregnation characteristics. In addition, in the case of the negative electrode of Comparative Example 2, which has a relatively low mixture density, the negative electrode of Comparative Example 2 shows desired or improved rate characteristics and electrolyte impregnation characteristics but has a low capacity per volume. That is, it can be seen that the negative electrode of Comparative Example 1 and the negative electrode of Comparative example 2 have a trade-off relationship between capacity and charge-discharge characteristics with each other. For reference, the capacity per volume can be estimated in consideration of the specific capacity of the finally produced negative electrode, and a thickness and mixture density of each region of the negative electrode active material layer in Table 2.

On the other hand, the negative electrodes of Examples 1 to 3 exhibit improved rate characteristics and electrolyte impregnation characteristics while securing a high capacity (capacity per volume). It is determined that this improves lithium-ion mobility in the upper layer portion having a relatively low mixture density to improve the rapid charging-discharging characteristics, and secures a high capacity (capacity per volume) in the lower layer portion having a relative high mixture density. As a result, according to example embodiments of the present disclosure, it is possible to provide a rechargeable lithium battery having a high capacity, and improved charge and discharge characteristics may be provided by having different mixture densities, amounts of binder, and porosities in each region in the negative electrode active material layer.

In addition, the negative electrodes of Examples 4 and 5 show improved specific capacity, rate characteristics, and electrolyte impregnation characteristics compared to the negative electrode of Comparative Example 3 in which only the hole forming process was performed. That is, the rechargeable lithium battery according to example embodiments of the present disclosure selectively removes the binder in a surface of the negative electrode active material layer to lower the mixture density, and includes holes with appropriate or desired size and depth. Accordingly, the example embodiments of the present disclosure can achieve a high specific capacity, while improving lithium-ion mobility, thereby exhibiting fast charging and discharging characteristics.

Further, referring to Table 3 above, it can be seen that the negative electrode of Example 4 in which a hole forming process was performed after a surface treatment process has a better capacity per volume when a mixture density in Table 2 is considered together, as compared with the negative electrode of Comparative Example 4 in which a surface treatment process was performed after a hole forming process. This is believed to reduce or minimize the reduction in capacity per volume of the cell, as the increased thickness through the surface treatment process is compensated for by pressing through the physically pressurized hole forming processing, as described above.

The negative electrode for a rechargeable lithium battery according to example embodiments of the present disclosure, may have different mixture densities, amounts of a binder, and porosities for each region in the negative electrode active material layer. Thus, charge-discharge characteristics can be improved while high capacity is achieved. As a result, the rechargeable lithium battery according to example embodiments of the present disclosure, may have desired or improved capacity and rate characteristics.

In addition, the negative electrode for a rechargeable lithium battery according to example embodiments of the present disclosure, may further include a plurality of holes configured to bring the negative electrode active material layer into contact with an electrolyte, thereby further improving lithium-ion mobility through the holes.

While the present disclosure has been described with reference to example embodiments, it should be understood that these example embodiments are provided for illustrative purposes only and do not limit the scope of the present disclosure. Various modifications and equivalent arrangements may be made without departing from the spirit and scope of the appended claims. Accordingly, the described embodiments should be regarded as examples rather than limitations of the present disclosure.

What is claimed is:

1. A negative electrode for a rechargeable lithium battery, the negative electrode comprising:
a negative electrode current collector; and
a negative electrode active material layer on the negative electrode current collector,
wherein the negative electrode active material layer comprises a negative electrode active material and a binder, and
wherein the negative electrode active material layer comprises:
a first region adjacent to a surface of the negative electrode active material layer; and
a second region between the first region and the negative electrode current collector,
wherein a mixture density of the first region is smaller than a mixture density of the second region,
wherein a thickness of the first region is a depth from the surface to a point having a specific mixture density,
wherein the specific mixture density is in a range of about 0.7 times to about 0.95 times an average mixture density of the negative electrode active material layer, and
wherein a ratio of the thickness of the first region to a thickness of the negative electrode active material layer is in a range of about 0.01 to about 0.1.

2. The negative electrode as claimed in claim 1, wherein a ratio of a mixture density of the first region to a mixture density of the second region is in a range of about 0.7 to about 0.95.

3. The negative electrode as claimed in claim 1, wherein the mixture density of the first region is in a range of about 1.05 g/cc to about 1.6 g/cc, and
wherein the mixture density of the second region is in a range of about 1.35 g/cc to about 1.7 g/cc.

4. The negative electrode as claimed in claim 1, wherein an amount of the binder in the first region is less than an amount of the binder in the second region,
wherein the amount of the binder in the first region is greater than about 0 wt % and less than or equal to about 3 wt %, and
wherein the amount of the binder in the second region is greater than about 0 wt % and less than or equal to about 7 wt %.

5. The negative electrode as claimed in claim 1, wherein a porosity of the first region is greater than a porosity of the second region.

6. The negative electrode as claimed in claim 5, wherein the porosity of the first region is in a range of about 40 vol % to about 60 vol %, and
wherein the porosity of the second region is in a range of about 10 vol % to about 30 vol %.

7. The negative electrode as claimed in claim 1, wherein the negative electrode active material layer includes a plurality of holes.

8. The negative electrode as claimed in claim 7, wherein an average depth of the holes is a first depth, and
wherein a ratio of the first depth to a thickness of the negative electrode active material layer is in a range of about 0.05 to about 0.5.

9. The negative electrode as claimed in claim 8, wherein a ratio of a thickness of the first region to the first depth is in a range of about 0.1 to about 3.

10. The negative electrode as claimed in claim 7, wherein the holes are arranged at a pitch in a range of about 50 μm to about 100 μm,
wherein an average diameter of the holes is in a range of about 5 μm to about 40 μm, and
wherein a density of the holes is in a range of about 50 pt/mm² to about 500 pt/mm².

11. A negative electrode for a rechargeable lithium battery, the negative electrode comprising:
a negative electrode current collector; and
a negative electrode active material layer on the negative electrode current collector,
wherein the negative electrode active material layer comprises a negative electrode active material and a binder, and
wherein the negative electrode active material layer comprises:
a first region adjacent to a surface of the negative electrode active material layer; and
a second region between the first region and the negative electrode current collector,
wherein a porosity of the first region is greater than a porosity of the second region,
wherein a thickness of the first region is a depth from the surface to a point having a specific mixture density,
wherein the specific mixture density is in a range of about 0.7 times to about 0.95 times an average mixture density of the negative electrode active material layer, and
wherein a ratio of the thickness of the first region to a thickness of the negative electrode active material layer is in a range of about 0.01 to about 0.1.

12. The negative electrode as claimed in claim 11, wherein the porosity of the first region is in a range of about 40 vol % to about 60 vol %, and
wherein the porosity of the second region is in a range of about 10 vol % to about 30 vol %.

13. The negative electrode as claimed in claim 11, wherein a ratio of the mixture density of the first region to the mixture density of the second region is in a range of about 0.7 to about 0.95.

14. The negative electrode as claimed in claim 13, wherein the mixture density of the first region is in a range of about 1.05 g/cc to about 1.6 g/cc,
wherein the mixture density of the second region is in a range of about 1.35 g/cc to about 1.7 g/cc.

15. The negative electrode as claimed in claim 11, wherein an amount of the binder in the first region is less than an amount of the binder in the second region,
wherein the amount of the binder in the first region is greater than about 0 wt % and less than or equal to about 3 wt %, and
wherein the amount of the binder in the second region is greater than 0 wt % and less than or equal to about 7 wt %.

16. The negative electrode as claimed in claim 11, wherein the negative electrode active material layer comprises a plurality of holes.

17. The negative electrode as claimed in claim 16, wherein:
an average depth of the holes is a first depth, and
a ratio of the first depth to a thickness of the negative electrode active material layer is in a range of about 0.05 to about 0.5.

18. The negative electrode as claimed in claim 17, wherein a ratio of a thickness of the first region to the first depth is in a range of about 0.1 to about 3.

19. The negative electrode as claimed in claim 16, wherein the holes are arranged at a pitch in a range of about 50 μm to about 100 μm,
wherein an average diameter of the holes is in a range of about 5 μm to about 40 μm, and
wherein a density of the holes is in a range of about 50 pt/mm² to about 500 pt/mm².

20. A rechargeable lithium battery, comprising:
the negative electrode as claimed in 1;
a positive electrode comprising a positive electrode current collector, and a positive electrode active material layer on the positive electrode current collector; and
a separator between the negative electrode and the positive electrode.
